(19) United States
(12) Patent Application Publication
(10) Pub. No.: US 2025/0138334 A1
(43) Pub. Date: May 1, 2025

(54) SPECTACLE LENS REPLACEMENT STRUCTURE

(71) Applicant: PROHERO GROUP CO., LTD., TAINAN CITY (TW)

(72) Inventor: PEN-WEI CHEN, TAINAN CITY (TW)

(21) Appl. No.: 18/499,303

(22) Filed: Nov. 1, 2023

(51) Int. Cl. G02C 1/02

(52) U.S. Cl. CPC G02C 1/02; G02C 2200/06; G02C 2200/08

(57) ABSTRACT

The invention relates to a spectacle lens replacement structure that includes a frame, a switch, and a lens. The frame has an inlay groove, a pivot connecting portion, and a long opening. The long opening is connected with the inlay groove, at least a part of which corresponds to the pivot connecting portion. The switch is arranged in the long opening and has an insertion piece arranged at the other end thereof and a clamping portion that is movable and pivotally clamped to the pivot connecting portion. The lens has a lock hole and a concave groove, respectively, in the corresponding insertion piece and the pivot connecting portion. When the lens is embedded in the inlay groove, the pivot connecting portion and the clamping portion fit into the concave groove. Then press the switch into the frame and insert the insertion piece into the lock hole to complete the assembly.

### BACKGROUND OF THE PRESENT INVENTION

### Field of Invention

The present invention relates to a spectacle lens replacement structure, and in particular, refers to an innovative design that can quickly detach the lens from the frame and assemble it to the frame.

### Description of Related Arts

Conventional glasses often provide glasses with lenses that can be easily disassembled and assembled, allowing users to replace the lenses depending on the usage status, occasion, and when the lenses are damaged.

For example, Taiwan Pat. Pub. No. 1268384B “Eyeglasses with Lenses Changeable”. A perforation arranged in the center of the frame. An elastic engage block arranged above the nose bridge of the frame. A protruding rod protruding from the front end of the engage block. The protruding rod passes through the perforation. When the lens is assembled with the frame, a snap hole arranged in the center of the lens, and the engage block is inserted into the snap hole of the lens to fix the lens to the frame.

Although the structure of Taiwan Pat. Pub. No. 1268384B can achieve the effect of quick disassembly and assembly of the lens. However, the perforation of the frame penetrates the front surface of the frame, and the protruding rod penetrates outside the perforation, which damages the overall aesthetics of the glasses and thus affects the commercial value of the glasses.

The inventor of the present invention has developed the present invention in view of the shortcomings of the above-mentioned existing previous cases in actual implementation and use.

### SUMMARY OF THE PRESENT INVENTION

The main purpose of the present invention is to provide a spectacle lens replacement structure, in which the wearer can change the lens by himself at any time, and the lens changing is extremely convenient and fast. At the same time, the lens replacement structure will not damage the integrity of the spectacle from a perspective that a third party can view.

The above-mentioned purpose of the present invention is achieved by the following technologies:
a spectacle lens replacement structure, includes:
a frame, which has an inlay groove provided thereof, wherein an opening of the inlay groove faces downward, wherein due to the arrangement of the inlay groove, the frame has a front side wall and a rear side wall formed corresponding to the inlay groove, wherein the frame has a pivot connecting portion provided on the front side wall and protruding toward the rear side wall, a pivot ball body formed at the end of the pivot portion, a long opening provided on the rear side wall and passing through the thickness of the rear side wall, wherein the long opening is connected with the inlay groove, and at least a part of the long opening corresponds to the pivot connecting portion;
a switch, arranged in the long opening, wherein the switch has two opposite ends, wherein the switch has a clamping portion provided at one end thereof and an insertion piece extending toward the front side wall at the other end thereof, wherein the clamping portion has two clamping claws arranged thereof, wherein the two clamping claws correspondingly clamp the pivot ball body at the end of the pivot connecting portion, allowing the switch to pivot like a joint mechanism with the pivot ball body as the axis; and
a lens, wherein the upper edge of which is correspondingly embedded in the inlay groove of the frame, wherein the lens has a closed lock hole and a concave groove that is recessed downward from the upper edge of the lens respectively in the corresponding to the insertion piece and the pivot connecting portion,
wherein when the upper edge of the lens is inserted into the inlay groove, the concave groove allows the pivot connecting portion and the clamping portion holding the pivot connecting portion to enter, and when the end of the switch equipped with the insertion piece is pressed toward the front side wall, the insertion piece will be inserted into the lock hole to fix the lens on the frame.

The spectacle lens replacement structure as mentioned above, a protruding limiting protrusion is provided on the bottom surface of the insertion piece, when the insertion piece is inserted into the lock hole, the limiting protrusion will be adjacent to the front surface of the rear side wall.

The spectacle lens replacement structure as mentioned above, the switch has a pressing force-applying part that protrudes backward and is provided at one end corresponding to the clamping portion, when the switch is accommodated in the long opening, the pressing force-applying part will relatively protrude from the rear surface of the rear side wall.

### BRIEF DESCRIPTION OF THE DRAWINGS

FIG. 1 is an exploded view illustrating the frame, switch and lens in the spectacle lens replacement structure of the present invention.

FIG. 2 is a perspective view illustrating the spectacle lens replacement structure of the present invention, with the switch assembled on the frame but the upper edge of the lens has not yet been inserted into the inlay groove of the frame.

FIG. 3 is a perspective view illustrating the spectacle lens replacement structure of the present invention after the frame, switch and lens are assembled and the switch is in a locked state.

FIG. 4 is a top sectional view illustrating the spectacle lens replacement structure of the present invention after the frame, switch and lens are assembled and the switch is in a locked state.

FIG. 5 is a side sectional view illustrating the spectacle lens replacement structure of the present invention after the frame, switch and lens are assembled and the switch is in a locked state.

FIG. 6 is a top sectional view illustrating the spectacle lens replacement structure of the present invention after the frame, switch and lens are assembled and the switch is in an unlocked state.

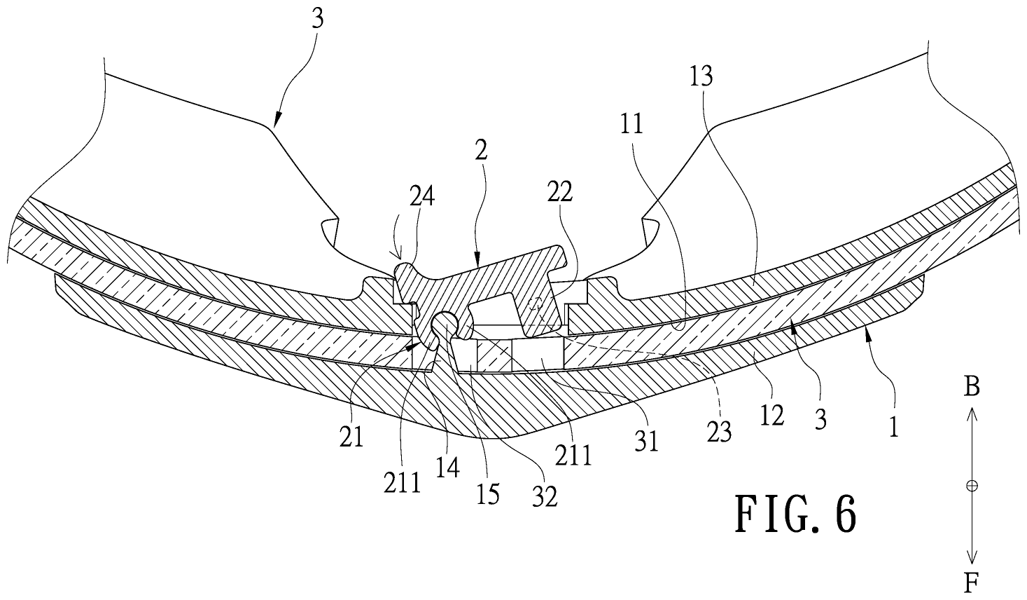

### DETAILED DESCRIPTION OF THE PREFERRED EMBODIMENT

In order to have a more complete and clear disclosure of the technical content, the purpose of creation and the effect achieved by the present invention, it is explained in detail below, and refer to the disclosed drawings and drawing numbers together.

First, in this article, the terms “forward,” “front side,” etc. are defined as the direction indicated by the arrow F shown on each view in the figure. The terms “backward,” “rear side,” etc. are defined as the direction indicated by the arrow B shown on each view in the figure. The terms “upper,” “top side,” etc. are defined as the direction indicated by the arrow U shown on each view in the figure. The terms “lower,” “bottom side,” etc. are defined as the direction indicated by the arrow D shown on each view in the figure.

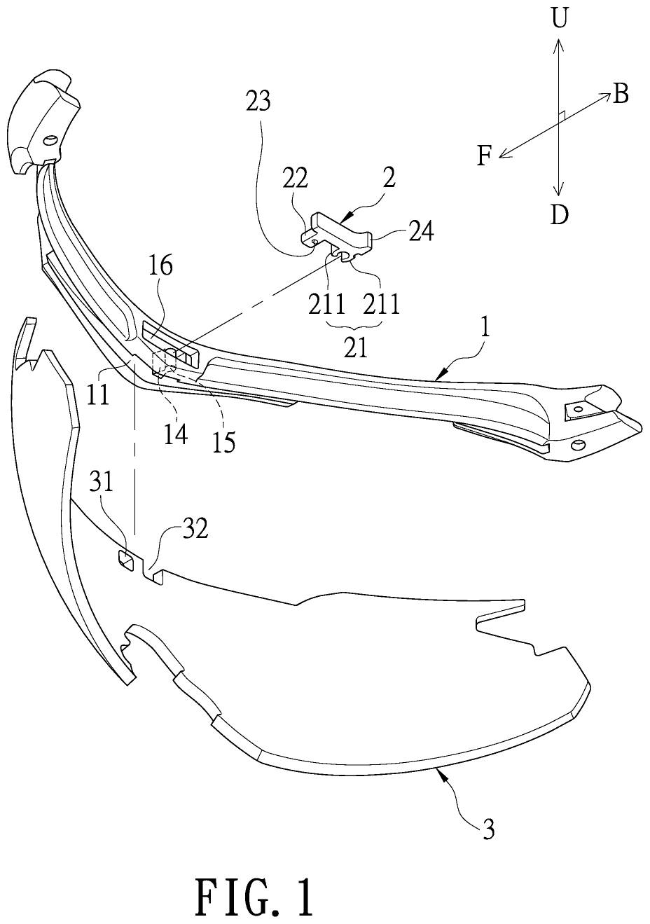

Referring to FIG. 1, which is an exploded view of the frame, switch and lens of the spectacle lens replacement structure of the present invention.

The spectacle lens replacement structure of the present invention includes a frame 1, a switch 2, and a lens 3, wherein
the frame 1 has an inlay groove 11 provided thereof, wherein an opening of the inlay groove 11 faces downward, wherein due to the arrangement of the inlay groove 11, the frame 1 has a front side wall 12 and a rear side wall 13 formed at the front and rear positions corresponding to the inlay groove 11, in other words, the front side wall 12 and the rear side wall 13 define the width of the inlay groove 11, and the width is relatively larger than the thickness of an upper edge of the lens 3, allowing the upper edge of the lens 3 to be embedded in the inlay groove 11, in addition, the frame 1 has a pivot connecting portion 14 provided on the front side wall 12 and protruding toward the rear side wall 13, and a pivot ball body 15 formed at the end of the pivot portion 14, wherein the frame 1 has a long opening 16 provided on the rear side wall 13 and passing through the thickness of the rear side wall 13, so that the long opening 16 is connected with the inlay groove 11, and at least a part of the long opening 16 corresponds to the pivot connecting portion 14;
wherein the switch 2 is correspondingly arranged in the long opening 16 of the frame 1, wherein the switch 2 has two opposite ends, and the switch 2 has a clamping portion 21 provided at one end thereof, wherein the clamping portion 21 has two clamping claws 211 arranged thereof, wherein the two clamping claws 21 correspondingly clamp the pivot ball body 15 at the end of the pivot connecting portion 14 on the frame 1, allowing the switch 2 to pivot like a joint mechanism with the pivot ball body 15 as the axis, wherein the switch 2 has an insertion piece 22 extending toward the front side wall 12 at the other end thereof;
wherein the upper edge of the lens 3 is correspondingly embedded in the inlay groove 11 of the frame 1, wherein the lens 3 has a closed lock hole 31 and a concave groove 32 respectively provided at positions corresponding to the insertion piece 22 of the switch 2 and the pivot connecting portion 14 of the frame 1, wherein the concave groove 32 is recessed downward from the upper edge of the lens 3.

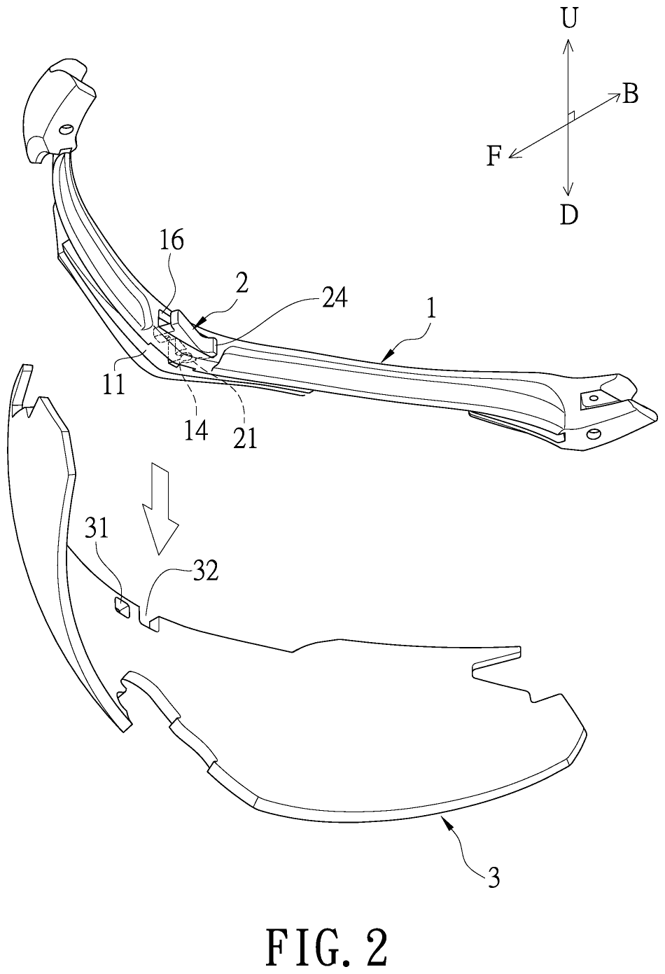

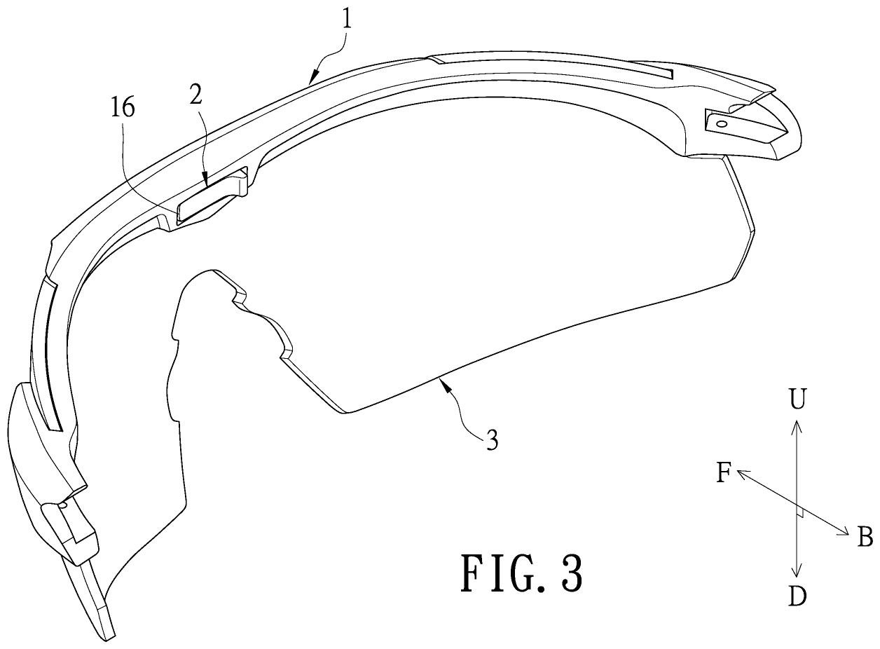

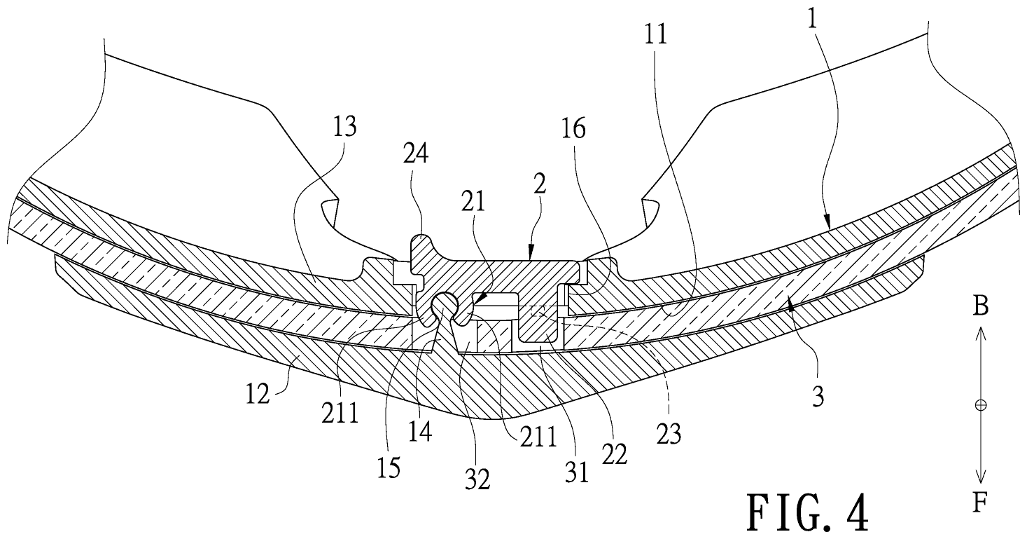

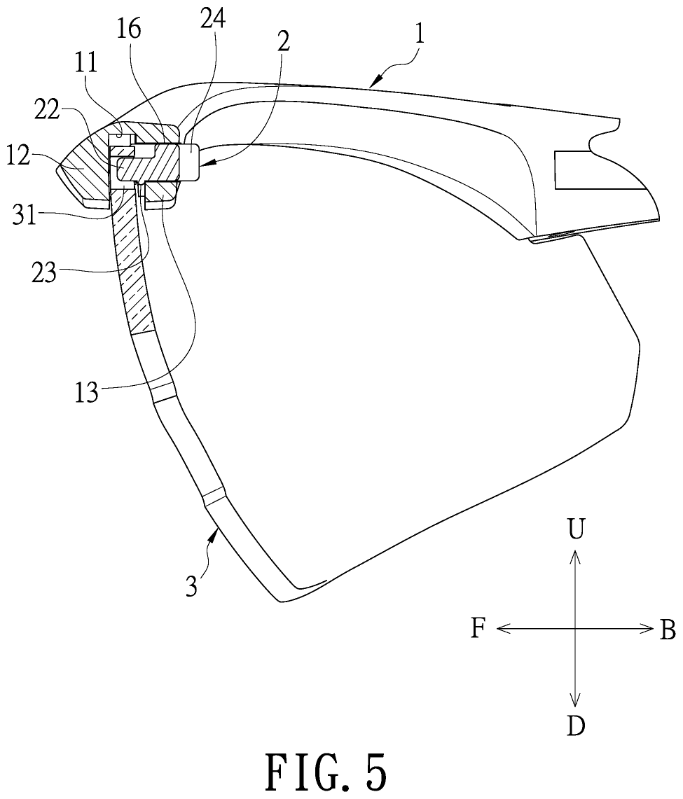

Referring to FIGS. 2-5, FIG. 2 illustrates the unembedded state in which the switch 2 is assembled on the frame 1 but the upper edge of the lens 3 is not embedded in the inlay groove 11 of the frame 1; FIGS. 3-5 illustrate that the upper edge of the lens 3 is inserted into the inlay groove 11 of the frame 1 and the switch 2 is in a locked state.

First, the clamping portion 21 of the switch 2 corresponds to the pivot connecting portion 14 of the frame 1, and the two clamping claws 211 of the clamping portion 21 clamp the pivot ball body 15 on the pivot connecting portion 14, so that the switch 2 is pivotally connected to the frame 1, and is correspondingly accommodated in the long opening 16 of the frame 1.

When the upper edge of the lens 3 is inserted into the inlay groove 11 of the frame 1, the concave groove 32 on the lens 3 allows the pivot connecting portion 14 of the frame 1 that protrudes from the front side wall 12 and is located across the inlay groove 11 and the clamping portion 21 of the switch 2 that holds the pivot connecting portion 14 to enter therein, so that the upper edge of the lens 3 is inserted into the inlay groove 11 of the frame 1 without any obstruction.

Then, press the end of the switch 2 corresponding to the insertion piece 22 toward the front side wall 12 of the frame 1 so that the insertion piece 22 is inserted into the closed lock hole 31 of the lens 3, thereby fixing the lens 3 to the frame 1.

In a preferred embodiment of the spectacle lens replacement structure according to the present invention, a protruding limiting protrusion 23 is provided on the bottom surface of the insertion piece 22. When the insertion piece 22 is inserted into the closed lock hole 31, the limiting protrusion 23 will be close to the front surface of the rear side wall 13 of the frame 1 to form a blocking point to prevent the insertion piece 22 of the switch 2 from easily detaching from the closed lock hole 31 of the lens 3, so that the assembly relationship between the lens 3 and the frame 1 is stabilized.

When the lens 3 is to be removed from the frame 1, the insertion piece 22 of the switch 2 is disengaged from the closed lock hole 31 of the lens 3, so that the lens 3 can no longer be locked by the switch 2 and can be removed from the inlay groove 11 of the frame 1.

In a preferred embodiment of the spectacle lens replacement structure according to the present invention, the switch 2 has a pressing force-applying part 24 that protrudes backward and is slightly tilted to the side, and is provided at one end corresponding to the clamping portion 21. When the switch 2 is accommodated in the long opening 16 of the frame 1, the pressing force-applying part 24 will relatively protrude from the rear surface of the rear side wall 13 of the frame 1, at the same time, the pressing force-applying part 24 is offset toward the outside relative to the axis of the pivot ball body 15, so that the two opposite ends of the switch 2 can move like a seesaw after being pivoted to the pivot ball body 15.

Therefore, when the lens 3 wants to be removed from the frame 1, it can be pressed directly from the pressing force-applying part 24 of the switch 2. After being pressed, the pressing force-applying part 24 of the switch 2 will rotate slightly with the pivot ball body 15 as the axis. This slight rotation causes the insertion piece 22 of the switch 2 to separate from the closed lock hole 31 of the lens 3. At this time, the lens 3 will no longer be locked and can be removed from the inlay groove 11 of the frame 1.

What is claimed is:

1. A spectacle lens replacement structure, comprising:
a frame, which has an inlay groove provided thereof, wherein an opening of the inlay groove faces downward, wherein due to the arrangement of the inlay groove, the frame has a front side wall and a rear side wall formed corresponding to the inlay groove, wherein the frame has a pivot connecting portion provided on the front side wall and protruding toward the rear side wall, a pivot ball body formed at the end of the pivot portion, a long opening provided on the rear side wall and passing through the thickness of the rear side wall, wherein the long opening is connected with the inlay groove, and at least a part of the long opening corresponds to the pivot connecting portion;
a switch, arranged in the long opening, wherein the switch has two opposite ends, wherein the switch has a clamping portion provided at one end thereof and an insertion piece extending toward the front side wall at the other end thereof, wherein the clamping portion has two clamping claws arranged thereof, wherein the two clamping claws correspondingly clamp the pivot ball body at the end of the pivot connecting portion, allowing the switch to pivot around the pivot ball body as the axis; and
a lens, wherein the upper edge of which is correspondingly embedded in the inlay groove of the frame, wherein the lens has a closed lock hole and a concave groove that is recessed downward from the upper edge of the lens respectively in the corresponding to the insertion piece and the pivot connecting portion,
wherein when the upper edge of the lens is inserted into the inlay groove, the concave groove allows the pivot connecting portion and the clamping portion holding the pivot connecting portion to enter, and when the end of the switch equipped with the insertion piece is pressed toward the front side wall, the insertion piece will be inserted into the lock hole to fix the lens on the frame.

2. The spectacle lens replacement structure as claimed in claim 1, wherein a protruding limiting protrusion is provided on the bottom surface of the insertion piece, when the insertion piece is inserted into the lock hole, the limiting protrusion will be adjacent to the front surface of the rear side wall.

3. The spectacle lens replacement structure as claimed in claim 2, wherein the switch has a pressing force-applying part that protrudes backward and is provided at one end corresponding to the clamping portion, when the switch is accommodated in the long opening, the pressing force-applying part will relatively protrude from the rear surface of the rear side wall.

4. The spectacle lens replacement structure as claimed in claim 1, wherein the switch has a pressing force-applying part that protrudes backward and is provided at one end corresponding to the clamping portion, when the switch is accommodated in the long opening, the pressing force-applying part will relatively protrude from the rear surface of the rear side wall.
